(19) United States
(12) Patent Application Publication
(10) Pub. No.: US 2002/0143595 A1
(43) Pub. Date: Oct. 3, 2002

(54) Method and system for compliance management

(76) Inventors: Theodore W. Frank, Chagrin Falls, OH (US); Gary M. Fingerhut, Solon, OH (US); Ganesh Laxminarayan, Beachwood, OH (US)

Correspondence Address: MORGAN & FINNEGAN, L.L.P., 345 Park Avenue, New York, NY, 10154, US

(21) Appl. No.: 09/776,994

(22) Filed: Feb. 5, 2001

(51) Int. Cl. G06F 17/60

(52) U.S. Cl. 705/8; 709/205

(57) ABSTRACT

A method and system for compliance management includes incident management and/or workflow management components. The system and method maintains accurate records of work-related incidents, such as a sexual harassment complaint or a chemical spill. The system also interacts with other data management systems and components to obtain a complete record of the incident. The work flow system executes activities in the incident management system. For example, the workflow system advises a user as to who should be notified in case of an incident, what forms must be completed, and what information must be collected. The use of this compliance system assists in the implementation for business related programs such as Good Faith Compliance Program for any type of organization, which may reduce incidents and provide some protection from potential litigation. Additionally, this system and method aids users in the evaluation and investigation processes.

### BACKGROUND OF THE INVENTION

1. Field of the Invention

This invention generally relates to a system and method of providing compliance management for users, and more particularly relates to a computerized web-based compliance management system that keeps a complete record of an incident and procedural workflow while guiding the user to a resolution and assisting in reduction of future incident occurrences.

2. Description of Related Art

Historically, compliance to federally imposed regulations and procedures are handled by a company's human resource staff, regulatory staff or quality control staff. Compliance programs typically have been in a written format by many companies. Administrative staff members generally spend time referring back to these written policies for use in investigating alleged violations, auditing procedures to make sure standards are met and other related tasks. Significant amounts of time and revenue are required for these activities. Challenges for complying with various regulations continue to mount as companies are being asked to demonstrate compliance with and increasing number of regulatory, procedural and ethical conduct requirements.

The growing administrative challenge of compliance management includes, for example, assessing and interpreting requirements, monitoring regulatory changes, developing site specific plans, implementing worldwide training and auditing performance. These activities represent significant organizational responsibilities, high administrative costs and potential exposure litigation due to compliance failure. A study done by Rochester Institute of Technology found that about sixty different federal agencies develop, implement and enforce regulations that result in compliance costs of about $668 billion dollars a year.

Assessing and consolidating compliance control activities and providing field division support would assist in identifying pitfalls, prevent incidents, protect company assets from costly litigation, and decrease insurance costs. However, current methods and systems used for compliance management have failed to provide any significant cost savings and incident reduction. A survey done by Corporate Legal Times in 1997 found that 86% of the companies interviewed had compliance policies in place and almost 60% indicated that they had claims, disputes investigations, and litigation associated with the same policies covered by their written compliance programs.

The National Safety Council estimated that the cost to American business due to accidents and emergencies in 1998 alone was $125.1 billion dollars. The Occupational Safety and Health Administration (OSHA) conducted over 89,000 inspections in 1999 and assigned penalties of $151 million dollars for compliance violations at the state and federal level. With these levels of cost this is an imperative need for a system and method for compliance management to reduce the overall occurrence of incidents and provide adequate responses to the incidents once they occur.

However, current written compliance programs have failed to provide any real reduction in the occurrence of incidents and reduction of losses. With the constant increase of regulations and procedure changes, administrative staffs are struggling to maintain compliance with the numerous requirements. In addition, when incidents do occur, it is often difficult to capture a complete record of the incident and events that lead up to the incident in order to prevent similar incidents from occurring in the future.

Therefore, a need exists in the art that would allow compliance management that keeps a complete record of an incident while guiding the user to a resolution and assisting in reduction of future incident occurrences. The system and method should maintain accurate records of work-related incidents, and interact with other data management systems and components to obtain a complete record of the incident. The system should also provide advisement to a user as to who should be notified in case of an incident, what forms must be completed, and what information must be collected. Finally, the system should assist in the implementation for business related programs such as Good Faith Compliance Program for any type of organization, which may reduce incidents and provide some protection from potential litigation.

### SUMMARY OF THE INVENTION

The present invention avoids disadvantages enumerated above as well as other disadvantages. One aspect of the invention involves a method for providing a compliance management system. The method includes receiving information about an incident, and extracting information related to the incident from external interfaces to obtain a complete record of the incident. Information is received about an incident and updated until the incident is resolved. Performance of tasks related to the incident is measured to assist in identifying deficiencies and implementing improvements. In addition, the user is guided through the steps required for appropriately responding to the incident.

Another aspect of the invention involves a compliance management system for incident and workflow management. The system includes a memory device, and a processor disposed in communication with the memory device. The processor is configured to receive information about an incident. The processor is also configured to extract information related to the incident from external interfaces to obtain a complete record of the incident, and receive updated information about an incident until the incident is resolved. The processor allows performance measurements of tasks related to the incident that can assist in identifying deficiencies and implementing improvements.

These aspects and other objects, features, and advantages of the present invention are described in the following Detailed Description which is to be read in conjunction with the accompanying drawings.

### BRIEF DESCRIPTION OF THE DRAWINGS

FIG. 1 is a schematic block diagram depicting one implementation of the system of the present invention;

FIG. 2 is a schematic flow diagram depicting the flow of information within the system of FIG. 1;

FIG. 3 is a schematic flow diagram depicting data access within the system of FIG. 1;

FIG. 4 is a schematic flow diagram depicting an auditing feature within the system of FIG. 1;

FIG. 5 is a schematic flow diagram illustrating the operation of the system and interaction between a user and the system in FIG. 1;

FIG. 6 is a schematic flow diagram illustrating extraction of information from external interfaces in the system of FIG. 1;

FIG. 7 is a schematic flow diagram illustrating a performance measuring feature within the system of FIG. 1; and

FIG. 8 is a schematic flow diagram depicting a guidance feature within the system of FIG. 1.

### DETAILED DESCRIPTION

The present invention relates to a system and method for compliance management. The method and system maintains accurate records of work-related incidents, such as a sexual harassment complaint or a chemical spill. The system also interacts with other data management systems and components to obtain a complete record of the incident. For purposes of this description, the term “incident” refers to any alleged or actual violation of a regulation that would make an organization out of compliance with that regulation, standard, procedure, or best practice (company defined standard) or rule. The incident may or may not be work-related depending on the implementation of the compliance management system.

The compliance system includes two components, which are a workflow system and an incident management system. The incident management system maintains accurate record keeping of incidents, and interacts with other database components to obtain a complete incident record. The incident management also routes/handles variances based upon specific variables, like for example, answers to questions, data, number of incidents, expert systems and the like. The work flow system executes activities in the incident management system. For example, the work flow system advises a user as to who should be notified in case of an incident, what forms must be completed, and what information must be collected. The use of this compliance system assists in the implementation of business related programs such as a Good Faith Compliance Program for any type of organization. Good Faith Compliance Program (GFCP) provides a guideline or best practice methodology for companies to follow which provides protection to the companies from litigation and reduce the occurrence of incidents.

The principles of the invention can be understood with reference to a system and method that provides an Internet-based software application designed to manage all compliance activities and create customized plans and training programs. In today's fast moving, competitive environment, administrative staff and management are charged with finding new ways to manage compliance activities while demonstrating effectiveness and improving outcomes. The present invention provides assistance to companies for managing their compliance activities with less effort and lower costs.

Some of the features of the present invention include customized compliance plans and training programs by specific location and employee function, delivery of e-learning programs for fast and effective organizational learning about compliance topics, delivery of online interviews (expert systems, surveys, etc.) and quicker distribution of regulatory information and policies for efficient change management.

The present invention also allows the monitoring and measuring of a variety of task performances at the facility to ensure compliance with regulations and standards. A well-documented audit trail is created by the present invention that assists in regulatory investigations and legal scrutiny. Improvement in communication of policies, industry news and best practices are available through the utilization of the present invention. Increased quantity and accuracy of reports for documentation of an incident is also provided by the present invention.

Depending on the implementation, the present invention utilizes a browser-based software application accessed through the Internet, which enables organizations to share and maintain data easily and economically. The Internet allows companies to take advantage of software applications without major hardware investments, additional personnel or a complex systems infrastructure. Employees are allowed to log-on anywhere there is an Internet connection: work, home, remote offices and even airports and hotels.

A variety of compliance topics ranging from health and safety to securities laws is available on the compliance system. For example, regulations relating to employment law areas, such as the Fair Labor Standards act (FLSA), Americans with Disabilities Act (ADA), Affirmative Action Plan (AAP), and Equal Employment Opportunity(EEO) are available for access and compliance management with the system. Depending on the implementation, other issues related to occupational safety and health regulations are available for compliance management using the present invention. For example, such regulatory areas include, but are not limited to, Occupational Safety and Health Administration (OSHA), Food and Drug Administration (FDA), and the Internal Revenue Service (IRS).

One example of regulations that are given by these administrative bodies is Good Manufacturing Practice regulations (GMPs). GMPs are used by pharmaceutical, medical device and food manufacturers as they produce and test products that people use. In the United States (U.S.), the Food and Drug Administration (FDA) has issued these regulations as the minimum requirements. These regulations are known to change from time to time and can become quite costly to an offender if found not in compliance with these regulations. Most countries have their own GMPs for drug and medical device manufacturers. Thus, an organization that is operating on a worldwide scale is faced to contend with different standards in different countries. This variation of regulations can be a tremendous liability to a company attempting to maintain compliance with these regulations. The present invention allows a user to maintain regulatory compliance regardless of the country or regulatory entity.

In one variant of the present invention, two interfaces for user access to the system is provided. The system can be accessed either an administrator or an employee. The administrator function is typically assigned to managers responsible for managing compliance activities, and is equipped with more versatility to create and distribute plans, policies and training programs as well as monitor employee activity. An organization can designate as many administrators as needed. A primary administrator role can be created, and managed from a central location such as a corporate office. Decentralization of responsibility is also available by having administrator duties assigned to several locations. The system is flexible and scalable to the user's needs.

Employees who need to fulfill requirements are also considered “users” and have a different set of functions. Employees are provided with a simple page format that gives notification of any news or new requirements associated with their jobs or roles. The employees can then directly access the required policies and training to fulfill their requirements. The system accommodates immediate online training and registration for instructor-led classes. The system empowers the user to evaluate the effectiveness of the user's particular compliance programs. This empowerment can result in a safer and more ethical workplace. Reduced costs from fewer incidents and administration that is more efficient are the results of this system.

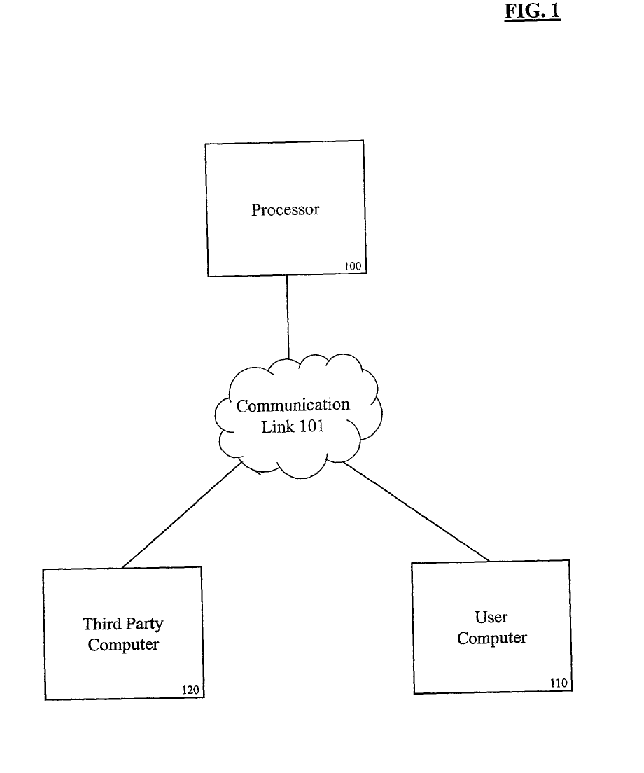

Referring to the drawings, shown in FIG. 1 is a schematic block diagram representing an example system constructed to illustrate and operate according to the principles of the present invention. Shown in the figure is a processor 100 which schematically represents a network, mainframe computer, processor, in communication with or including an image storage/retrieval system, or a database of information submitted as described herein. When specifically operating in accordance with the principles of the invention, the processor 100 operates as a receiver, translator, processor, and distributor of information related to compliance management. The processor 100 responds to requests by identifying the appropriate reference file or item, retrieving it from the image storage/retrieval system or its own storage, and providing it for display on a user's computer 110. Similarly, the processor 100 receives regulatory and standards information and, depending upon the item, converts the item to an image file, a textual file or some other file suitable for storage and later for retrieval and display using known techniques.

The block 110 depicts a user's computer that utilizes the processor. As previously stated, the user can be an employee or manager of a company involved in compliance management. The user may also be any third party or entity, which deals with compliance management. The user may also be one of a multitude of entities using the processor.

The user is connected to the processor by a communication link 101. Depending on the implementation, link 101 can be a data link or communication link such as the Internet. Such data link can alternatively be, but is not limited to, an electronic data link, optical fiber connection, wireless data connection or any other known connection used for data transfer, for example, over the Internet. Depending upon the implementation, link 101 can operate in one or more modes of transmission. For example, such modes include radio frequency transmissions, optical transmission, microwave transmission, digital or analog transmission, or other known data transmission mode. Link 101 may further include connections such as by physical means. Such physical means includes postal service, facsimile, verbal communication (with or without voice recognition), written communication (with or without optical character recognition) and the like.

A third party computer 120 is also connected to processor 100 by a communication link 101. The third party computer 120 can be any entity or group of entities, which are interested in compliance of regulations and standards. The third party may include for example a regulatory body such as the Department of labor (DOL), FDA or other such regulatory entity. New regulations from these entities can be received directly to the user through link 101 or through the processor 100. The processor 101 can incorporate the new regulations into the user's compliance programs to ensure the user complies with the new rules.

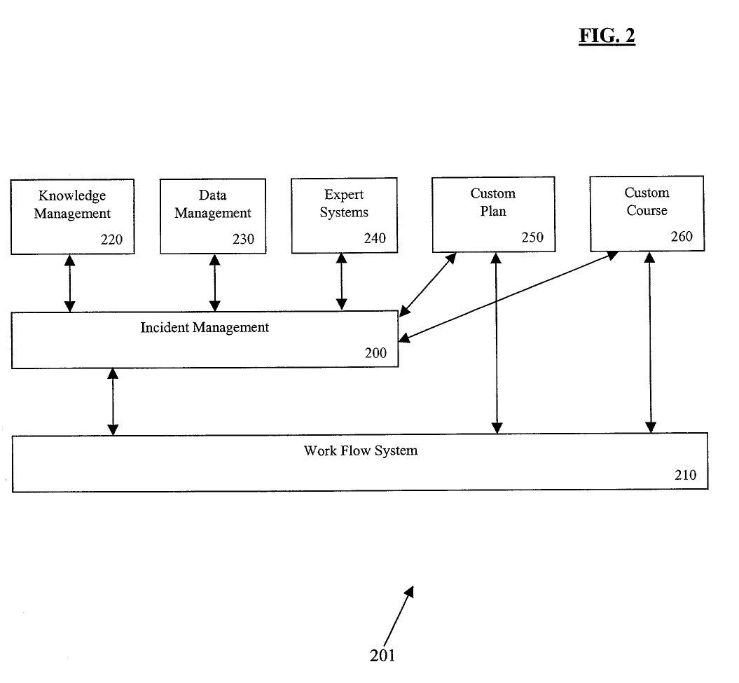

The operation of an example system employing the principles of the invention as schematically defined by FIG. 2 and described above is as follows. FIG. 2 illustrates one example schematic flow diagram depicting the creation or operation relative to FIG. 1. A compliance management system 201 is shown comprising the following components. An incident management system 200 allows an organization to conduct an investigation of an incident in a fair, discrete, and well-documented manner. The primary focus of the incident management system is to provide rigorous record keeping functions from the beginning to the end or resolution of an incident. Additionally, information prior to the incident is also collected as well as information after the incident for monitoring and incident prevention purposes. The incident management system 200 also has the ability to model changes to work flows and/or available resources to assess associated performance impact. For example, workflow metrics are evaluated and based on the evaluation performance is assessed and changes can be implemented to avoid the occurrence of future incidents.

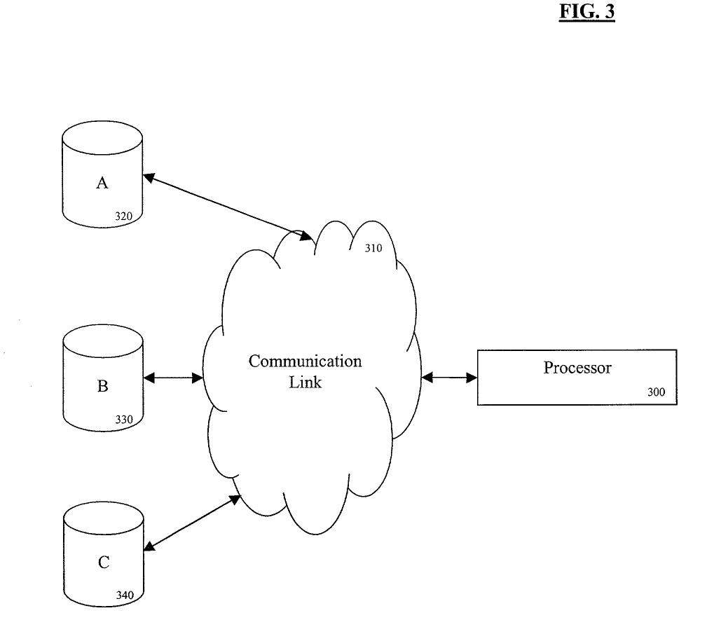

Depending on the implementation, the incident management system includes the following functions. Creation of documents for new incidents is facilitated. All participants involved in the incident and a description of the incident is accounted for in the incident management system. Existing incidents are managed to facilitate consistent updates. Updates include for example interview sessions with the complainant and accused. Forms required for reporting the incident and capturing data are also generated by the incident management system. Administrative reports such as incident status reports, costs, risk assessment, evaluation reports and the like, are also generated by the incident management system. The incident management system 200 also provides a secure environment for data entry. Data collection from external interfaces, which are further explained in detail in FIG. 3, is also provided by incident management system 200.

Shown in FIG. 2, is an example of three different types of external interfaces that interact with the incident management system. These external interfaces are exemplary and in no way are meant to limit the various types of interfaces available to the incident management system. The external interfaces shown are knowledge management 220, data management 230 and expert systems 240. Knowledge management 220 refers to the management of regulations, policies, best practices know to the user. Data management 230 includes the management of information that is collected during/after/before an incident. Expert system 240 relates to those systems, which controls the implementation of regulations, policies, or best practices. Data modification and cleansing is minimized after submission of facts during an incident to maintain data validity. This minimization is accomplished by providing the system with various safeguards that prevent tampering with the recorded data.

A work flow system 210 interacts with the incident management system 200. The work flow system 210 allows a user to define business processes for compliance management. A business process for purposes of this description is defined as a group of logically related tasks that use resources of an organization to provide defined results in the support of the organization's compliance objectives. Each business process comprises one or more activities that takes an input, adds value to it, and provides an output. The work flow system 210 will then execute these business process models while monitoring performance and costs. For example, in handling a sexual harassment case, the Human Resources department of an organization will be able to document all the activities and tasks required ensuring that a proper and efficient investigation is conducted. During the incident investigation, the user is walked through the process as implemented by the organization. Thus, guidance is provided to the user and customized to fit the specific organization.

The work flow system 210 further includes the performance of the following functions. The provision of metrics to measure performance tasks, help identify deficiencies and implement improvements to an organization's compliance management program, is established through work flow system 210. Validation and execution of business process workflow is also provided by the work flow system. The work flow system 210 further provides bench marking features to monitor the incident management during the life cycle of the incident occurrence. Predicative capabilities regarding activities/collection of data associated with compliance failures are also allowed. For example, the system and method allows the user to predict potential compliance failures based on the collected data of previous failures. In this manner, future compliance failures can be avoided.

A customized plan 250 and customized training courses 260 interfaces with the work flow system 210. The customized plan 250 is developed based on the deficiency or need of the specific organization to meet compliance standards. Similarly, training courses are made available to users based on the need or deficiencies in compliance detected by the work flow system. The courses that give training to employees to decrease the occurrence of incidents may be offered on-line to facilitate ease of access to the user. Incorporation of expert systems, training and plans/policies into the work flows are also allowed. For example, plans, policy procedures, and general documents are generated based on the modeling of the work flow to avoid future compliance failures.

FIG. 3 illustrates data collection from external interfaces. Shown is a processor 300 in communication with external interfaces 320, 330, and 340 labeled storage units A, B, and C respectively. The processor 300 is communicating to the storage units through a communication link 310. Similar to link 101, communication link 310 can be a data link or communication link such as the Internet. Such data link can alternatively be, but is not limited to, an electronic data link, optical fiber connection, wireless data connection or any other known connection used for data transfer, for example, over the Internet. Link 310 does not necessarily bear any relationship with link 101 with regards to the specific type of communication link used. Thus, for example, link 101 may be a wireless communication and link 310 may be an optical fiber connection.

Extraction of information relating to an incident occurs through processor 300 to allow the user a complete record of the incident. For example, storage unit A can contain personal records, storage unit B may contain maintenance records and storage unit C may contain time sheets. In the situation of a chemical spill by a driver driving a chemical transport truck, the user may be assisted in the investigation to review the driver's personal record to check to see if any prior incidents of this type was done by the driver. In addition, the personal records of the driver may indicate a prior alcohol or drug abuse problem that the investigator may want to pursue further during the investigation, such as giving a drug test. Maintenance records in storage unit B may indicate prior mechanical problems with the vehicle the driver was driving when the chemical spill incident occurred. Such information can be useful in the reduction of future incidents. Storage unit C may indicate, for example, that the driver of the vehicle worked double shifts the day before the incident occurred. This type of information can also be useful to the investigator in reducing the potential of further incidents.

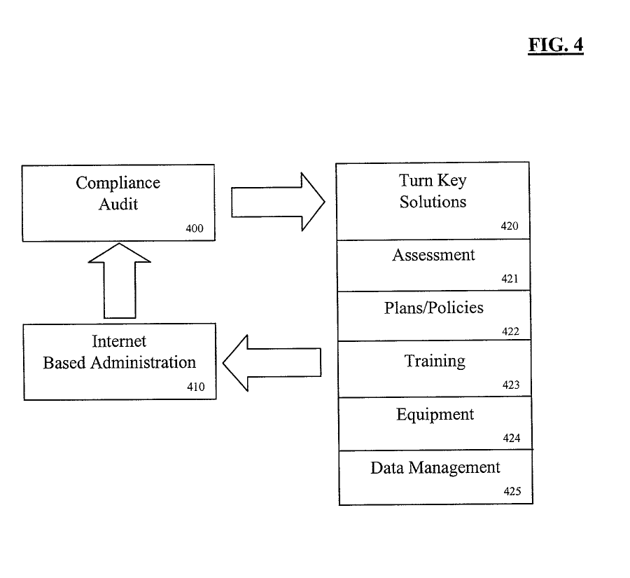

FIG. 4 illustrates an auditing feature within the compliance system. Shown in block 400 is a compliance audit, which provides in block 420 turn key solutions to a user's compliance needs. These solutions include, but are not limited to, assessments 421, plans and policies 422, training 423, equipment 424 and data management 425. These solutions may be interfaced with an Internet based administration 410. The following describes these features in further detail.

The compliance management system of the present invention is a single source solution that identifies, develops and implements compliance systems to solve user's most pressing issues. As an Internet-based compliance management system, the present invention designs, delivers and integrates comprehensive systems to protect your employees and company assets, prevent litigation and provide measurable results.

Compliance audit 400 illustrates the compliance management system performing audits on a broad scale or on a specific topic that identify the areas of compliance negatively impacting the user's organization. A variety of regulatory topics audited provides unparalleled resources to identify areas of risk and vulnerability. Below in Table I is illustrated an example of some of the subject matter or areas of compliance that can be audited by the compliance management system.

TABLE I
Areas of Compliance

| Areas of Risk | Ensuring Compliance In |
|---|---|
| Competitive | Fair competition and competitive markets |
| Practices | |
| Business Conduct | Ethical behavior in accordance with a company's |
| | guidelines |
| Employment and | Fair, non-discriminatory and satisfying workplace |
| Labor Practice | |
| Contractual | Reasonable compliance with bona fide business |
| | contracts |
| Anti-Corruption | Transparency and compliance with laws controlling |
| | bribery and other payments to government officials |
| Environmental, | Environmental protection, conservation of natural |
| Health & Safety | resources, healthy workplace and safe products |
| Securities | Free trading of stocks and other publicly held |
| | securities, including the prevention of insider trading |
| Financial | Financial reports are timely, complete, reliable, and |
| Reporting | fairly presented |
| Privacy and Data | Appropriate care and use of private information about |
| Protection | consumers or employees |
| Consumer | Buyers and users are safe, fair, and appropriately |
| Protection | informed |
| Knowledge and | Appropriate care and use of intellectual property both |
| Information | within the company and through joint venture |
| | relationships |
| International | Regulations and policies governing foreign trade and |
| Trade | related transactions |

Subject matter can also be specialized in compliance issues for industries such as healthcare, banking, insurance, investment management, brokerage, utilities, pharmaceuticals, energy and telecommunications.

The compliance management system, depending on the implementation, can deliver through Internet based administration 410 the latest in policies, procedures and best practices. Through a consultative process, the user is assisted to identify areas where improved compliance management will have the highest impact on the user's business. Plans are developed by the compliance management system, which are customized to the users needs. Systems are implemented that improve employee performance through reduced incidents of unsafe and unethical behavior.

Turn key solutions 420 is comprised of key elements that provide necessary components used to manage the user's compliance infrastructure.

In one variant, Internet-based compliance software in the compliance management system is used to manage corporate policy and compliance activities throughout the user's organization, which can be worldwide. This comprehensive tool can integrate and facilitate administration for management and employees. The compliance management system empowers companies to improve compliance activities so the user can manage proactively instead of reactively. The user can choose to manage compliance activity through the compliance management system from a central location, or distribute responsibility to regional or local branches. Local branch managers can maintain records, add and track status of employee compliance activity, access plans and policies and run reports for review by corporate management.

Some of the benefits of solutions 420 include for example: the creation of plans and establish policies throughout the user's organization, monitoring and measuring of performance at the facility, department and employee level to ensure compliance, quantitative results gained so that the user can demonstrate improvements in employee performance and administrative processes, the creation of a well documented audit trail when faced with regulatory investigations and legal scrutiny, the tracking of all regulations and implement effective change management, and improvement of communication of policies and industry news while creating best practices throughout the user's organization.

Thus, turnkey solutions 420 involves compliance solutions that will streamline and improve administrative processes, reduce incidences and attempt to protect the user from litigation. The end result is a customized solution for topics related to Environmental, Health & Safety compliance such as OSHA standards, or workplace ethics such as privacy, fraud and abuse.

Assessment 421 includes compliance experts providing a thorough assessment that reveals the specific parts of the regulatory requirements or best practices affecting the user's organization. The user's current program is evaluated and gaps are bridged.

Plans and Policies 422 involve working with the user, and depending on the implementation, the web-based compliance management system to develop site-specific and employee-specific plans that include components the user needs to demonstrate compliance for all locations required by regulations.

Training 423 illustrates training programs offered both online and on-site on any compliance topic. In addition, customized training content is developed to incorporate site-specific requirements. Systematic teaching methods and tools increase skills retention and build confidence among employees, therefore positively impacting performance.

Equipment, Products and Programs 424 illustrate when the user's solution requires specialized equipment, such as emergency response equipment.

Data Management 425 illustrates administration through integrated data management that tracks employee training status, training schedules and generates reports that provide documentation for meetings, audits and inspections.

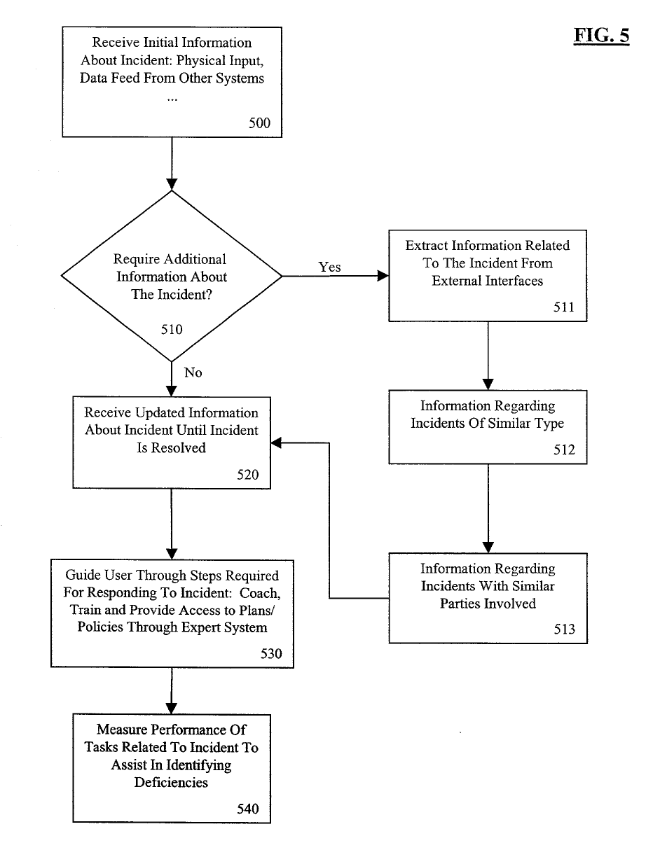

FIG. 5 depicts one implementation of the operation of the compliance management system. Block 500 illustrates receiving the initial information about an incident. This information can include, for example, the parties involved in the incident, summary of the non-compliance of regulations, the regulations involved, and statements from witnesses. Block 510 illustrates the determination of whether additional information is required about the incident. If the user determines more information is desired, block 511 shows information is extracted from external interfaces as previously described. This information may include, for example, information regarding incidents of similar types 512 and information regarding incidents with similar parties involved. The compliance management system searches these external interfaces for such information. If a match occurs between the type of incident or parties involved with previously recorded incidents, the information is provided to the user. This access to this type of information can be invaluable in the reduction of future incidents.

Block 520 illustrates receiving updated information about the incident until the incident is resolved. This type of information can include for example, results from drug or alcohol tests of employees, interviews with the parties involved, and the like. Block 530 illustrates guiding the user through the steps required for responding to the incident appropriately. The compliance management system gives instructions to the user based on the regulations and standards involve assisting the user in maintaining compliance with the regulations involved. The guidance may be in the form of a checklist, flowchart, formal instructions or other similar formats. Block 540 illustrates measuring performance of tasks related to the incident in order to assist identifying deficiencies and recommend corrective actions. The tasks involved in the incident can be examined prior to, during, and after the incident to monitor how well the corrective actions are doing in the reduction of future incidents.

Again, depending on the implementation, it is recognized that the order or sequence of tasks illustrated can be in any order to achieve the desired end result of compliance management with the advantages discussed herein.

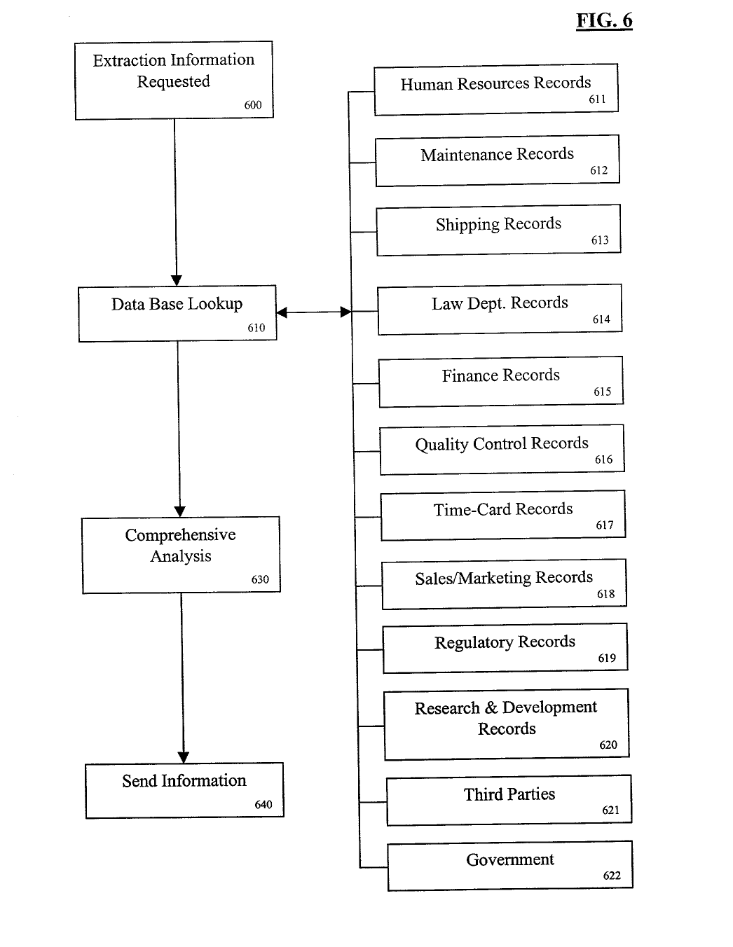

FIG. 6 depicts one implementation of the process involved in extracting information from external interfaces. Block 600 illustrates that extraction information is requested. Depending on the implementation involved, the request can be made by the user voluntarily or by the compliance management system automatically if the system determines that more information is required to resolve the incident. Block 610 illustrates a database look up function that allows the system to interface with external units. Such external interfaces may include for example, but are not limited to, human resource records 611, maintenance records 612, shipping records 613, law department records 614, finance records 615, quality control records 616, time-card records 617, sales/marketing records 618, regulatory records 619, or research and development records 620. Additionally, third parties as shown in block 621 can also be interfaced for data lookup. Third parties include, but are not limited to, outside regulatory consultants, regulatory agencies, universities, libraries, standards boards/organizations and the like. Block 622 depicts governmental parties that also can be interfaced for data. Such governmental parties include, but are not limited to, governmental agencies, government officials, government boards/organizations, government run programs, and the like. A comprehensive analysis is done as shown in block 630 to filter out relevant information that could relate to the incident. Such factors use in this filter process include, parties involved, site involved, type of incident, material involved and the like. The information is then sent to the user for use in the incident investigation as indicated in block 640.

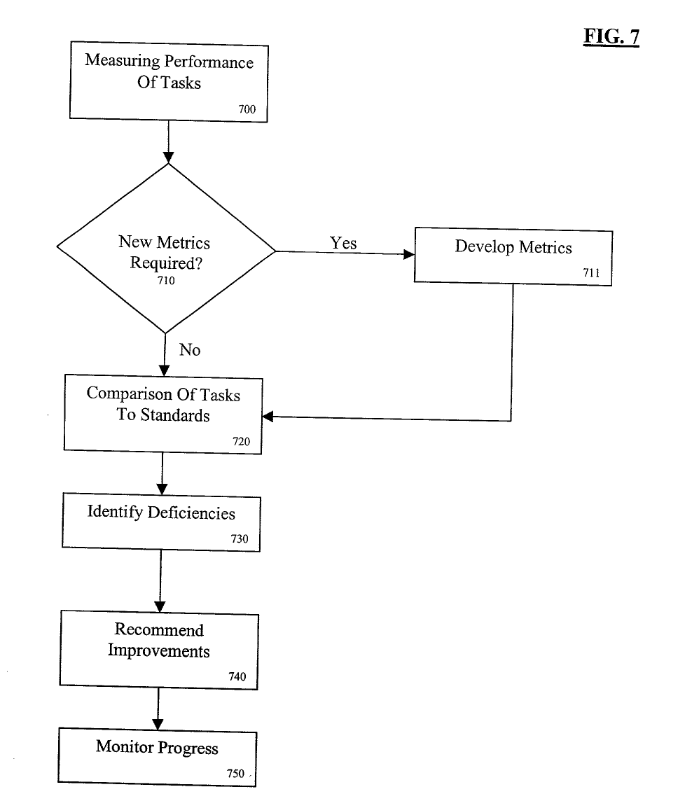

FIG. 7 illustrates one implementation of measuring performance of tasks involved in the incident. Performance measuring can be chosen by the user, or recommended by the compliance management system, as indicated in bock 700. A determination is made as to whether new modes of measurements or metrics are required as depicted in block 710. If so, the compliance management system develops the new metrics as in block 711. If not, a comparison of the task involved is made to the standards set for those specific tasks. The standards may be internally imposed by the user or set by some regulatory body. Deficiencies in those tasks are identified by the compliance management system as shown in block 730. The system recommends improvements in block 740 and monitors the progress of the recommended changes in the tasks shown by block 750.

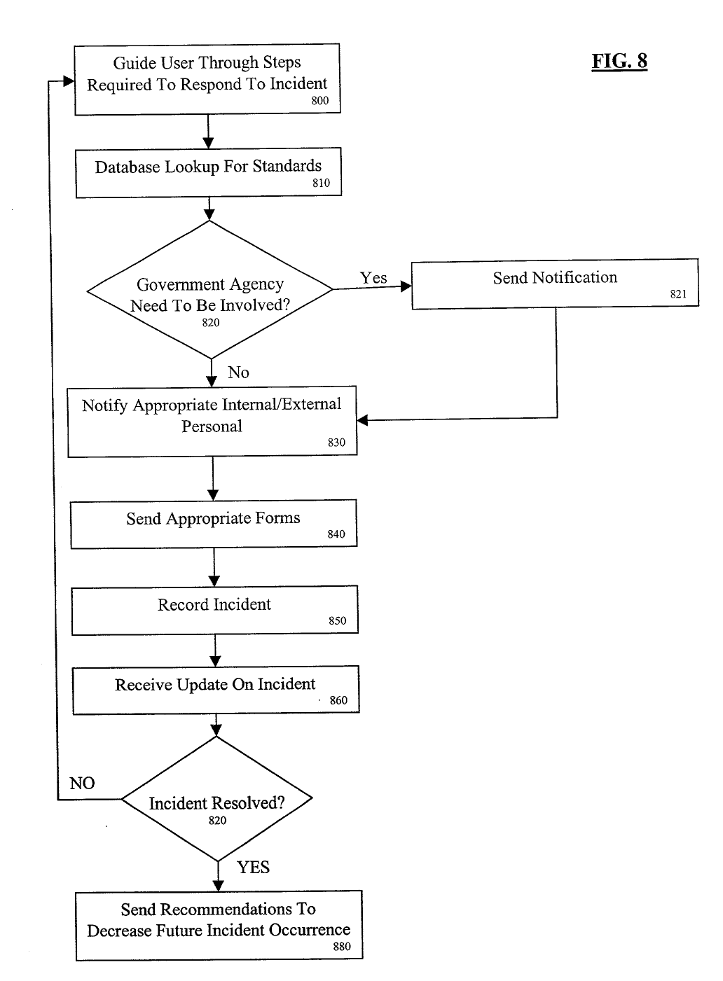

FIG. 8 illustrates one implementation of the guidance given to a user by the compliance management system. Block 800 shows that guidance for the user is either requested by the user or recommended by the compliance management system. Steps required to respond appropriately to the incident are given by referring to the standards set that related to the specific incident involved. This lookup of standards is depicted as block 810.

A determination can be made as illustrated by block 820 of whether a governmental agency or regulatory body needs to be notified of the incident. If so, the compliance management system may send notification to such an entity as indicated in block 821. In addition, notification may be sent by the system to the appropriate internal or external personal. Such personnel may include for example, managers, human resource personnel, and internal or external legal counsel. The compliance management system sends the appropriate forms and records the incident as indicated in blocks 840 and 850, respectively. Updates may be continually received as illustrated in block 860. A determination is periodically made by wither the user or the compliance management system whether the incident is resolved or compliance to the violated regulation has been restored. If not, the user is then guided by the system through the required steps to resolve the incident. If the incident is resolved, recommendations are made to the user for use to decrease or eliminate future occurrence of the incident. These recommendations are based on information received about the incident, extracted information form external interfaces and performance measurement d of the tasks related to the incident.

It should be understood that the above description is only representative of illustrative examples of various embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Depending on the implementation, it is further recognized that the order or sequence of tasks illustrated in the figures are merely intended to be exemplary of the concepts defined herein. It is understood that the tasks shown in the figures can be in any order to achieve the desired end result.

Alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent.

What is claimed is:

1. A method for providing a computerized compliance management system, comprising
receiving information about an incident; and
extracting information related to the incident from at least one external interface to obtain a complete record of the incident; and
dynamic generation of site specific workflow using the information.

2. The method of claim 1 further including sending a recommendation for corrective action for reduction of incident occurrence.

3. The method of claim 1 further including sending information to guide a user through the steps required for responding to the incident.

4. The method of claim 3 wherein the user guiding further includes generating an investigation checklist for use as a guide.

5. The method of claim 1 further including performing expert system interviews.

6. The method of claim 1 further including searching for data on prior incidents of this type and prior incident history of parties involved in the incident.

7. The method of claim 1 further including routing variances based upon specific variables that include answers to questions, incident data, and number of incidents.

8. The method of claim 1 further including auditing information entered about the incident.

9. The method of claim 8 wherein the information audit further includes minimizing data modification after submission of facts during the incident to maintain data validity.

10. A method for providing a computerized compliance management system, comprising
receiving information about an incident from a user;
extracting information related to the incident from at least one external interface to obtain a complete record of the incident; and
measuring performance of tasks related to the incident to assist in identifying deficiencies and implementing improvements.

11. The method of claim 10 further including sending a recommendation for corrective action for reduction of incident occurrence based on measured performance.

12. The method of claim 10 further including generating forms for incident and data capture.

13. The method of claim 10 further including generating a report about the incident.

14. The method of claim 10 further including guiding the user through the steps required for responding to the incident.

15. The method of claim 10 further including maintaining a secure environment for data entry and data collection from the external interfaces.

16. The method of claim 10 further including generating a calendar for follow-ups on the incident.

17. The method of claim 16, wherein the calendar generating further includes creating bench marks to monitor the incident management.

18. The method of claim 10 further including involving a governmental agency in the process of responding to the incident.

19. The method of claim 10 further including recording internal and external costs caused by the incident.

20. The method of claim 19 wherein the internal and external costs include at least one of settlement to claimants, external counsel fees expert witness fees, court reporter fees, third party mediator costs, arbitrator fees, internal legal department staff costs, claim management costs, interviewing participants testifying in depositions, trial costs, damage to company's reputation, damage to employee morale or damage to company's good will.

21. A method for providing a computerized compliance management system, comprising
extracting information related to an incident from at least one external interface to obtain a complete record of the incident;
receiving updated information about an incident until the incident is resolved; and
guiding a user through the steps required for responding to the incident.

22. The method of claim 21 further including sending a notice to a user, the notice including at least one of contacts that should be alerted of the incident, forms to be completed, and information to be collected.

23. The method of claim 21 further including measuring performance of tasks related to the incident to assist in identifying deficiencies and implementing improvements.

24. The method of claim 23 further including executing online training based on a measured task deficiency.

25. The method of claim 21 further including maintaining a secure environment for data entry and data collection from the external interfaces.

26. The method of claim 21 further including validating at least one task used to reduce the occurrence of the incident.

27. The method of claim 21 further including offering an online course about incident prevention in response to the incident.

28. A method for providing a computerized compliance management system, comprising
receiving initial information about an incident from a user;
extracting information related to the incident from at least one external interface to obtain a complete record of the incident;
receiving updated information about an incident until the incident is resolved; and
measuring performance of tasks related to the incident to assist in identifying deficiencies and implementing improvements.

29. The method of claim 28 further including sending a recommendation for corrective action based on the measured performance to reduce incident occurrence.

30. The method of claim 28 further tracking the progress of the incident.

31. A method for providing a computerized compliance management system, comprising
receiving initial information about an incident from a user;
extracting information related to the incident from at least one external interface to obtain a complete record of the incident;
receiving updated information about the incident until the incident is resolved;
measuring performance of tasks related to the incident to assist in identifying deficiencies and implementing improvements; and
guiding a user through the steps required for responding to the incident.

32. A computerized compliance management system for incident and workflow management, comprising:
a memory device; and
a processor disposed in communication with the memory device, the processor configured to:
receive information about an incident, and
extract information related to the incident from external interfaces to obtain a complete record of the incident.

33. The system of claim 32 wherein the processor is further configured to send a recommendation for corrective action for reduction of incident occurrence.

34. The system of claim 32 wherein the processor is further configured to guide a user through the steps required for responding to the incident.

35. The system of claim 32 wherein the processor is further configured to track the progress of the incident.

36. The system of claim 32 wherein the processor is further configured to search for data on prior incidents of this type.

37. The system of claim 32 wherein the processor is further configured to search for data on prior incident history of parties involved in the incident.

38. The system of claim 32 wherein the processor is further configured to audit information entered about the incident.

39. The system of claim 38 wherein the processor is further configured to minimize data modification after submission of facts during the incident to maintain data validity.

40. A computerized compliance management system for incident and workflow management, comprising:
a memory device; and
a processor disposed in communication with the memory device, the processor configured to: receive information about an incident from a user,
extract information related to the incident from external interfaces to obtain a complete record of the incident, and
measure performance of tasks related to the incident to assist in identifying deficiencies and implementing improvements.

41. The system of claim 40 wherein the processor is further configured to send a recommendation for corrective action for reduction of incident occurrence based on measured performance.

42. The system of claim 40 wherein the processor is further configured to maintain a secure environment for data entry and data collection from the external interfaces.

43. The system of claim 40 wherein the processor is further configured to generate a calendar for follow-ups on the incident.

44. The system of claim 43 wherein the processor is further configured to create bench marks to monitor the incident management.

45. The system of claim 40 wherein the processor is further configured to notify a governmental entity concerning the progress of responding to the incident.

46. A computerized compliance management system for incident and workflow management, comprising:
a memory device; and
a processor disposed in communication with the memory device, the processor configured to:
extract information related to an incident from external interfaces to obtain a complete record of the incident,
receive updated information about the incident until the incident is resolved, and
guide a user through the steps required for responding to the incident.

47. The system of claim 46 wherein the processor is further configured to send a notice to a user, the notice including at least one of contacts that should be alerted of the incident, forms to be completed, or information to be collected.

48. The system of claim 46 wherein the processor is further configured to measure performance of tasks related to the incident to assist in identifying deficiencies and implementing improvements.

49. The system of claim 48 wherein the processor is further configured to execute online training based on a measured task deficiency.

50. The system of claim 46 wherein the processor is further configured to validate at least one task used to reduce the occurrence of the incident.

51. A computerized compliance management system for incident and workflow management, comprising:
a memory device; and
a processor disposed in communication with the memory device, the processor configured to:
receive initial information about an incident from a user,
extract information related to the incident from external interfaces to obtain a complete record of the incident,
receive updated information about the incident until the incident is resolved, and
measure performance of tasks related to the incident to assist in identifying deficiencies and implementing improvements.

52. A computerized compliance management system for incident and workflow management, comprising:
a memory device; and
a processor disposed in communication with the memory device, the processor configured to:
receive initial information about an incident from a user,
extract information related to the incident from external interfaces to obtain a complete record of the incident,
receive updated information about the incident until the incident is resolved,
measure performance of tasks related to the incident to assist in identifying deficiencies and implementing improvements, and
guide a user through the steps required for responding to the incident.

53. A computerized compliance management system for incident and workflow management, comprising:
means for receiving information about an incident; and
means for extracting information related to the incident from external interfaces to obtain a complete record of the incident.

54. The system of claim 53 further including means for tracking the progress of the incident.

55. A computerized compliance management system for incident and workflow management, comprising:
means for receiving information about an incident from a user;
means for extracting information related to the incident from external interfaces to obtain a complete record of the incident; and
means for measuring performance of tasks related to the incident to assist in identifying deficiencies and implementing improvements.

56. A computerized compliance management system for incident and workflow management, comprising:
means for extracting information related to an incident from external interfaces to obtain a complete record of the incident;
means for receiving updated information about the incident until the incident is resolved; and
means for guiding a user through the steps required for responding to the incident.

57. The system of claim 56 further including means for measuring performance of tasks related to the incident to assist in identifying deficiencies and implementing improvements.

58. A computerized compliance management system for incident and workflow management, comprising:
means for receiving initial information about an incident from a user;
means for extracting information related to the incident from external interfaces to obtain a complete record of the incident;
means for receiving updated information about the incident until the incident is resolved; and
means for measuring performance of tasks related to the incident to assist in identifying deficiencies and implementing improvements.

59. The system of claim 58 further including means for sending a recommendation for corrective action based on the measured performance to reduce incident occurrence.

60. The system of claim 58 further including means for tracking the progress of the incident.

61. A computerized compliance management system for incident and workflow management, comprising:
means for receiving initial information about an incident from a user;
means for extracting information related to the incident from external interfaces to obtain a complete record of the incident;
means for receiving updated information about the incident until the incident is resolved;
means for measuring performance of tasks related to the incident to assist in identifying deficiencies and implementing improvements; and
means for guiding a user through the steps required for responding to the incident.

62. A computer readable medium comprising:
code for receiving information about an incident;
code for extracting information related to the incident from external interfaces to obtain a complete record of the incident; and
code for measuring performance of tasks related to the incident to assist in identifying deficiencies and implementing improvements.

63. The computer readable medium further including code for guiding a user through the steps required for responding to the incident.

64. A method for providing a computerized compliance management system, comprising:
receiving initial information about an incident;
extracting information related to the incident from at least one external interface to obtain a complete record of the incident; and
storing the extracted information and the internal information in a database for utilization by compliance personnel.

65. A method for providing a computerized compliance management system, comprising
receiving information about an incident;
extracting information related to the incident from at least one external interface to obtain a complete record of the incident;
sending information to guide a user through the steps required for responding to the incident;
tracking the progress of the incident;
tracking the progress of the corrective actions taken in response to the incident;
searching for data on prior incidents of this type;
searching for data on prior incident history of parties involved in the incident; and
sending a recommendation for corrective action for reduction of incident occurrence.

66. A method for providing a computerized compliance management system, comprising
receiving information about an incident from a user;
extracting information related to the incident from at least one external interface to obtain a complete record of the incident;
measuring performance of tasks related to the incident to assist in identifying deficiencies and implementing improvements;
generating forms for incident and data capture;
guiding the user through the steps required for responding to the incident;
maintaining a secure environment for data entry and data collection from the external interfaces;
generating a calendar for follow ups on the incident;
notifying a governmental entity concerning the progress of responding to the incident; and
sending a recommendation for corrective action for reduction of incident occurrence based on measured performance.

67. A method for providing a computerized compliance management system, comprising
receiving initial information about an incident from a user;
extracting information related to the incident from at least one external interface to obtain a complete record of the incident;
receiving updated information about the incident until the incident is resolved;
measuring performance of tasks related to the incident to assist in identifying deficiencies and implementing improvements;
generating forms for incident and data capture;
guiding the user through the steps required for responding to the incident;
maintaining a secure environment for data entry and data collection from the external interfaces;
generating a calendar for follow ups on the incident;
notifying a governmental entity concerning the progress of responding to the incident; and
sending a recommendation for corrective action for reduction of incident occurrence based on measured performance.
